(19) United States
(12) Patent Application Publication
(10) Pub. No.: US 2017/0216857 A1
(43) Pub. Date: Aug. 3, 2017

(54) SPRAY FOR CLEANING PRODUCTS

(71) Applicant: GOIZPER, S.COOP., Antzuola (Gipuzkoa) (ES)

(72) Inventor: Mikel LOITI URQUIA, Arrasate ( Gipuzkoa ) (ES)

(21) Appl. No.: 15/501,158

(22) PCT Filed: Aug. 3, 2015
(86) PCT No.: PCT/IB2015/055876

§ 371 Date: Feb. 1, 2017

(30) Foreign Application Priority Data
Aug. 5, 2014 (EP) 14382308.6

(51) Int. Cl. B05B 7/00; B05B 7/24; B05B 15/00; B05B 7/04

(52) U.S. Cl. CPC B05B 7/0037; B05B 7/0483; B05B 7/2467; B05B 15/005

(57) ABSTRACT

The spray comprises a container (1) intended to hold liquid for forming the cleaning mass and pressurised air for spraying it, the container (1) being dismantlably attachable to a head (3) bearing a manual pump (4) to increase the pressure of the air, the head (3) also having a supporting handle (23) with a pushbutton (24) operating the outlet valve (18) for the cleaning mass to the delivery nozzle (22), the spray having a manually replaceable mixing device (7, 26) located between the outlet conduit (8) for the liquid from the spray container (1) and the outlet of damping mass (20) controlled by the manual valve (18), the mixing device (7, 26) having different passage cross-sections for the liquid and the air present in the container (1) in order to adjust the spray to provide cleaning masses with a drier or wetter foam consistency.

This invention provides a spray for cleaning products of the type used for applications in the home, for the cleaning of various surfaces such as tiles or the like, upholstery of different types of furniture, etc., by applying a cleaning mass in the form of foam.

Sprays designed to provide a mass in the form of foam which is sprayed onto the object which has to be cleaned are already known and have various disadvantages, among which may be mentioned the impossibility of adjusting the sprays to provide so-called dry and wet foams, as the user desires, that is to say, masses of cleaning foam with a drier consistency which may be intended for particular surfaces of domestic objects, upholstery and carpets, and wetter masses, that is to say with a greater proportion of liquid, which are required for surfaces of a different type, such as tiles, glass or vehicles, in which the sprayed mass has to be extended over larger surfaces.

One of the objects of this invention is to provide a spray for cleaning products in the form of foam which easily enables the user to adjust the spray to obtain wetter or dryer foams, thus making the spray more appropriate for the work which has to be done.

The spray which is the object of the invention comprises a container for cleaning liquid, which partly fills the container, and also a manual pump to increase the pressure of the air occupying the rest of the internal capacity of the container. A dip pipe for the liquid picks this up close to the bottom of the container, driven by the pressure of the air present in the container, and delivers it to a mixer device, or a mixer device prior to delivery, which is provided by means of a valve that is manually operated through a pushbutton associated with the supporting handle or support for the spray, to provide ergonomic handling.

The mixer device is also designed to produce a controlled mixture of the liquid originating from the container and air also from the container, which will give rise to the formation of a mass with a foam consistency which then passes to the delivery device, which comprises a manually operated valve and an outlet tube with a damping mass of felt at its delivery outlet, partly closed off by a nozzle with a gauged passage. The damping mass in which the air and liquid become completely mixed preferably comprises a rectangular piece of felt rolled and inserted into a supporting piece.

This invention provides a mixer device with a replaceable body, which is connected to the top part of the outlet tube for the liquid from the container and which has an axial passage for the liquid and a transverse passage for the air, in such a way that the proportions between the cross-sections of these passages can be varied in accordance with the mass of cleaning foam which it is desired to obtain, whether wetter or drier. The mixing device can be replaced by the user, who will choose between a number provided by the vendor of the spray, so that the equipment can be adjusted for different types of cleaning foam.

In a preferred version the mixer device has a dip pipe of constant diameter for the entry of liquid and an air entry which is also of constant diameter, for example, of 9 mm and 0.8 mm respectively, although it is obvious that these figures may differ. Between the lower end where the liquid enters and the opening where the air enters the mixer device has a choke of variable cross-section whose specific value will give rise to different types of cleaning mass provided by the spray. For greater convenience, in a preferred version, various openings of predetermined value are provided for this choke, for example diameters of 1.5, 2 and 3 mm, giving rise to three possible mixer devices which the user can change at will in order to obtain different types of cleaning mass with a foam consistency having characteristics between wet and dry. As will be understood, the precise dimensions of the choke openings may vary within broad limits according to the type of the liquid used to form the mass and the particular type of mass which it is desired to obtain.

The spray to which this invention relates has an amorphous damper, especially of felt, at the outlet of the delivery conduit, this damper being inserted in a supporting piece and being retained by a front nozzle provided with a gauged outlet opening.

More specifically this invention comprises a spray according to claim 1. Preferred embodiments are described in the dependent claims.

For a better understanding representative drawings of a preferred embodiment of this invention are provided by way of an explanatory but not limiting example.

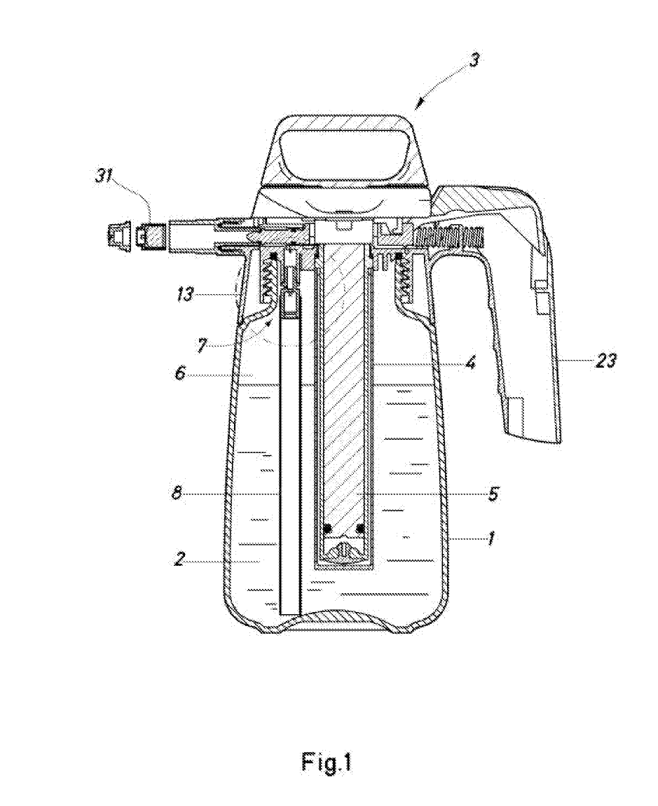

FIG. 1 shows a cross-section of the spray along its plane of symmetry.

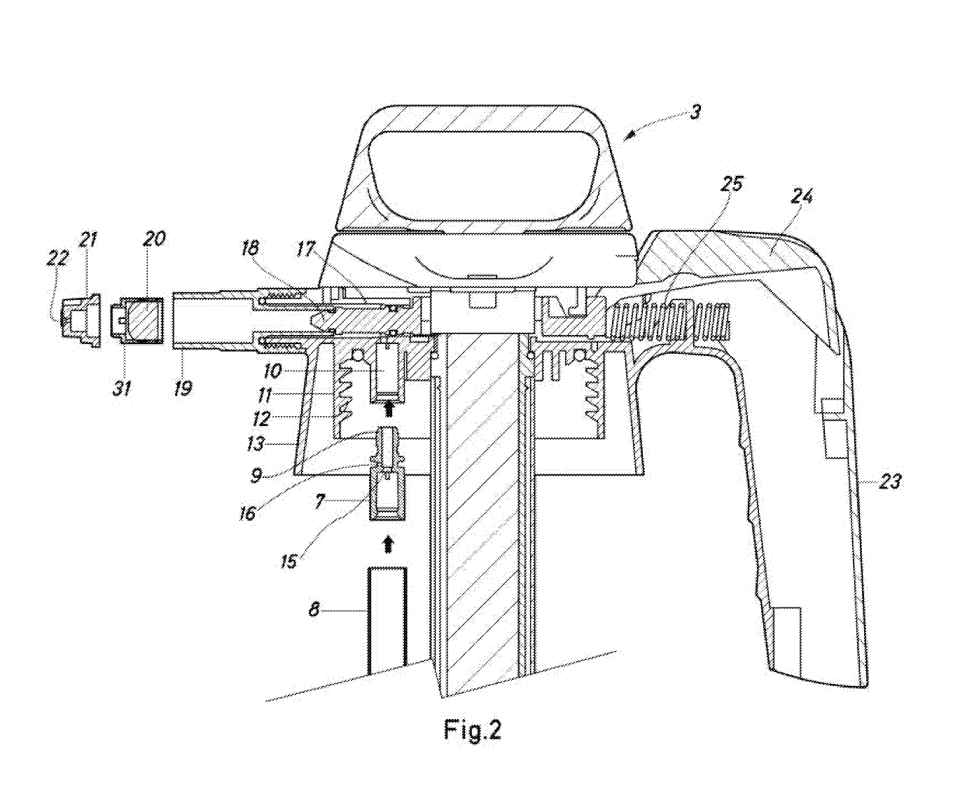

FIG. 2 shows the top or head part of the spray on a magnified scale.

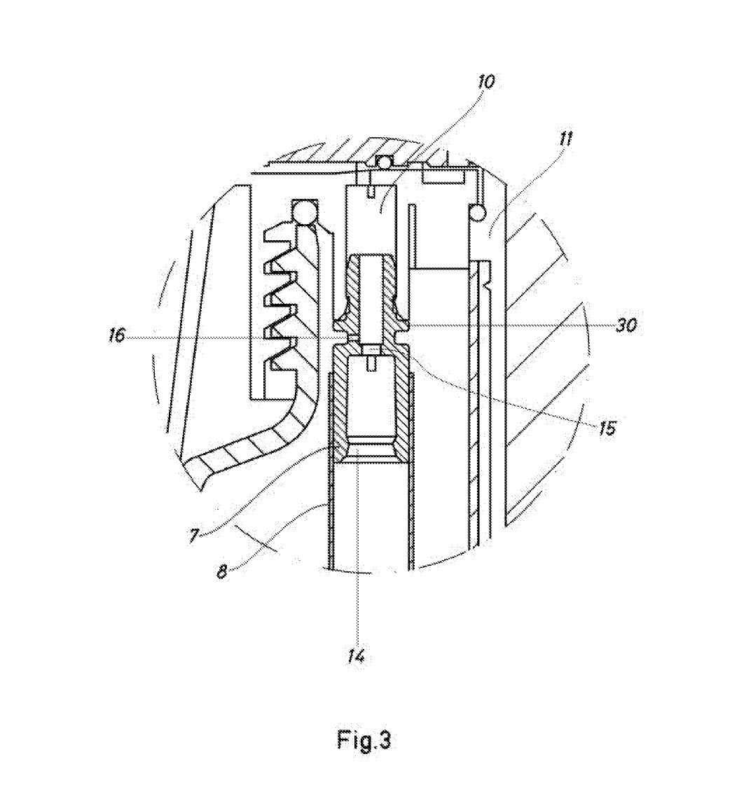

FIG. 3 shows a detail of the mixer device in cross-section.

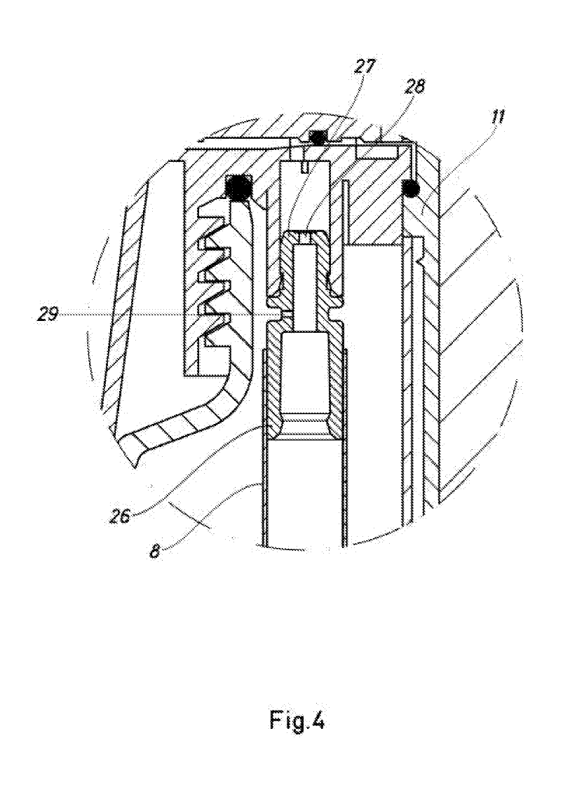

FIG. 4 shows a cross-section of a variant of the mixer device.

As will be seen in the drawings, the spray to which this invention relates comprises a container -1- intended to contain a liquid -2- to form the cleaning mixture, incorporating a manual pump device with an operating handle -3- and an inner tube -4- in which internal piston -5- moves, together with its seal and one-way valve of a type which is already known and which is designed so that the user can manually increase the pressure of the air mass -6- present in the top of container -1-.

Formation of the cleaning mass with a foam consistency takes place through a mixer device -7- incorporated in the top of tube -8- intended for the delivery of liquid -2-, the lower extremity of which is located in the vicinity of the bottom of container -1-. This mixer device, which will be seen in greater detail in FIGS. 2, 3 and 4, is attached by one extremity to the upper extremity of dip pipe -8- for the liquid, and at the other extremity -9- it is connected to a housing -10- in the head -11- of the spray, the head being for example connected by means of thread -12- to the upper throat portion of container -1-. This head may have an external skirt -13- which is intended to coincide by its lower end with the outer surface of container -1-, ensuring that the outer surface of the same is of a continuous nature.

Mixer -7- will be seen in greater detail in FIG. 3, and a variant of it is illustrated in FIG. 4. As will be seen in FIG. 3 the structure of the mixer device is in general a hollow cylindrical structure which is attached for example by pressure to the upper extremity of tube -8- and is likewise attached to housing -10- in head -11- of the spray through a combination of ribs and recesses or other appropriate system, the mixer also having an intermediate collar -30-, the top of which abuts the bottom edge of housing -10-. The mixer device has a lower opening -14- for the entry of liquid from dip pipe -8- and an intermediate choke -15- for the liquid, which has an adjustable diameter. Above this choke -15- the mixer device has a gauged opening -16- for the entry of air from part -6- of container -1-, which has been pressurised by the manual pump provided with handle -3-. During operation, the liquid originating from dip pipe -8- and the air entering via opening -16- mix to form a cleaning mass which will finally be in the form of a foam having the desired level of moisture content. The cleaning mixture then passes to conduit -17- in the head of the spray, controlled by manual valve -18-, and after that valve has been opened it passes to front nozzle -19- the front part of which bears damper mass -20- held in place by nozzle -21- provided with outlet opening -22-. This mass -20-, within which the air and the liquid finally become completely mixed, preferably comprises a rectangular length of felt which has been rolled up and inserted into a supporting piece -31-.

Valve -18- is operated axially from supporting handle -23- of the spray through a pushbutton -24- against which an opposing spring -25- acts.

Changing the passage diameters may give rise to the formation of masses having a drier or wetter foam consistency. In the simplest but not exclusive arrangement adopted for the invention a constant diameter is provided for dip pipe -8- and air inlet -16- and variable diameters, for example three separate versions, are provided for the passage of liquid through choke -15-. In a specific embodiment there are provided three mixer devices -7- having a constant diameter of the liquid aspiration opening corresponding to the extremity connected to dip pipe -8-, the latter being for example of 9 mm, the mixer having a passage opening -16- for air which also has a fixed value, for example 0.8 mm, with for example three different versions of mixer device -7-, having passages for liquid of 1.5 mm, 2 mm and 3 mm respectively in choke -15-, for example, although it is obvious that these values may be changed at the manufacturer's convenience, to adjust them to a specific use of the spray for different types of foam/different types of surfaces which have to be cleaned.

FIG. 4 shows a variant of the mixer device, in this case indicated by -26-, which has an outlet choke in its upper part, comprising a partly sealing partition -27- and an opening -28- which allows the premixed mass of liquid originating from pipe -8- and air originating from lateral gauged opening -29- to pass outwards.

In the examples illustrated and described mixer device -7- will give rise to a very dry foam if it has an opening of 1.5 mm in inner choke -15- and one of 0.8 mm for the passage of air, with a pipe -8- of 9 mm, given that the proportion of air with respect to liquid will be high. The nature of the cleaning mass will become gradually wetter with the intermediate two millimetre version of the choke opening and more so with the mentioned version having a choke opening of 3 mm, which will give rise to a wetter cleaning mass.

The variant in FIG. 4 which has an upper choke -27-28- will provide a very wet foam.

It is understood from the description that the spray can be provided together with several replaceable mixing devices, having each mixing device a different ratio between the size of the opening for the passage of air and the size of the opening for the passage of liquid, thus allowing to adjust the consistency of the foam by replacing one mixing device by another.

It will be understood that the description of an embodiment is purely of an explanatory but not limiting nature and that after studying this description, claims and drawings those skilled in the art will be able to introduce many variants into the invention which will remain with the scope thereof if they are included within the appended claims.

1. A spray for cleaning products comprising:
a container designed to contain a liquid for the formation of a cleaning mass and pressurised air for spraying,
a head bearing a manual pump to increase the pressure of the air, the head also having a supporting handle with a pushbutton for operating a valve for release of the cleaning mass to a delivery nozzle, and
a mixing device located between a liquid dip pipe in the container and a damping mass outlet controlled by the valve,
wherein the container can be dismantlably attached to the head,
the mixing device comprises respective passages for the liquid and the air, and
the mixing device is replaceable with a replaceable mixing device in which at least one of the respective passage has a cross-section different from the mixing device to adjust the spray to provide cleaning masses with a drier or wetter foam consistency according to the type of application and the user's requirements.

2. A kit comprising:
the spray for cleaning products according to claim 1, and
a number of replaceable mixing devices with different passage cross-sections.

3. The spray for cleaning products according to claim 1 wherein the mixing device is located between a top part of the liquid dip pipe and a housing in the head.

4. The spray for cleaning products according to claim 3, wherein the housing is configured to receive a top end of the mixing device having a recess which is configured to be engaged with a rib in the housing.

5. The kit according to claim 2, wherein the number of replaceable mixing devices have an internal choke between a lower end where the liquid enters and an opening where the air enters into the mixing device, and each replaceable mixing device has a different diameter for the passage of liquid.

6. The kit according to claim 5, wherein the internal choke is located between the entry of liquid in the replaceable mixing device and the air entry.

7. The spray for cleaning products according to claim 1 further comprising:
an amorphous damper mass at an outlet extremity of a delivery conduit of the head retained by a nozzle connected to the delivery conduit, and having a gauged outlet opening for the cleaning mass.

8. The spray for cleaning products according to claim 7, wherein the amorphous damper mass in which the air and liquid complete their mixing comprises a rectangular piece of felt, said rectangular piece of felt is rolled and is inserted into a supporting piece.
